(19) United States
(12) Patent Application Publication
(10) Pub. No.: US 2024/0338266 A1
(43) Pub. Date: Oct. 10, 2024

(54) CHASSIS MANAGEMENT SYSTEM AND CHASSIS MANAGEMENT METHOD

(71) Applicant: SUZHOU METABRAIN INTELLIGENT TECHNOLOGY CO., LTD., Suzhou, Jiangsu (CN)

(72) Inventor: Yulong HUANG, Suzhou, Jiangsu (CN)

(21) Appl. No.: 18/708,568

(22) PCT Filed: Sep. 27, 2022
(86) PCT No.: PCT/CN2022/121847

§ 371 Date: May 8, 2024

(30) Foreign Application Priority Data
Mar. 22, 2022 (CN) 202210279484.2

(51) Int. Cl. G06F 9/54

(52) U.S. Cl. CPC G06F 9/545; G06F 9/547

(57) ABSTRACT

A chassis management system and a chassis management method are provided. The chassis management system includes a hardware layer, a firmware layer, an operating system layer, an application layer, and a cluster management center; wherein the hardware layer includes a shared device accessed by a main baseboard manager controller (BMC) and a single-control affiliation device managed by each BMC, and the shared device is configured to collect chassis information and enables each control node of a cluster to be in network interconnection with a plurality of BMCs, respectively; the firmware layer includes a chassis management control module, the plurality of BMCs, and processors corresponding to the plurality of BMCs; the processors are configured to select the main BMC from the BMCs; the chassis management control module achieves network communication; the operating system layer communicates with the BMCs.

### CROSS-REFERENCE TO RELATED APPLICATION

This application claims the priority of the Chinese Patent application filed on Mar. 22, 2022 before the China National Intellectual Property Administration with the application number of 202210279484.2, and the title of “CHASSIS MANAGEMENT SYSTEM”, which is incorporated herein in its entirety by reference.

### FIELD

The present application relates to the technical field of storage and, more particularly, to a chassis management system and a corresponding chassis management method.

### BACKGROUND

A baseboard manager controller (BMC) is a remote management controller of a server, which may be configured to achieve the chassis management of a multi-controller storage product. When the server is not turned on, some operations such as firmware upgrading and machinery device querying may be performed on a server device. Compared with dual-control unified storage, unified high-end storage has better storage performance and higher reliability.

The unified high-end storage uses one frame with two controllers for device management. Each controller corresponds to one BMC. During chassis management, a method of master-slave synchronization is used to achieve data synchronization between all the BMCs. That is, each BMC needs to synchronize all pieces of hardware state data to the other three BMCs. This method has a large amount of data synchronization information, poor timeliness, and low chassis management efficiency.

### SUMMARY

A chassis management system is provided by the present application, which effectively improves the chassis management efficiency of a multi-controller storage product.

In order to solve the above technical problems, some embodiments of the present application provide the following technical solutions.

A chassis management system is provided by some embodiments of the present application, wherein the chassis management system includes: a hardware layer, a firmware layer, an operating system layer, an application layer, and a cluster management center;
wherein the hardware layer includes a shared device accessed by a main baseboard manager controller (BMC) and a single-control affiliation device managed by each BMC, and the shared device is configured to collect chassis information and configured to enable each control node of a cluster to be in network interconnection with a plurality of BMCs, respectively;
the firmware layer includes a chassis management control module, the plurality of BMCs, and processors corresponding to the plurality of BMCs: the processors are configured to manage the single-control affiliation devices of corresponding control nodes and select the main BMC from the BMCs: the chassis management control module is configured to achieve network communication;
the operating system layer is configured to communicate with and access the BMCs;
the application layer is configured to access the operating system layer by calling BMC interfaces and obtain hardware data information cached by the BMCs through the chassis management control module; and
the cluster management center is configured to manage the hardware data information, obtained by each control node by accessing all the BMCs, of all chassises.

Optionally, the shared device includes a chassis hardware arranged on a chassis frame, a network management board, and a chassis power supply: the shared device is connected to each BMC through an inter-integrated circuit (I2C):
the chassis hardware is configured to collect the chassis information and indicate the chassis information; and
the network management board is configured to provide a network interconnection function to interconnect each control node of the cluster to the BMCs, respectively.

Optionally, the chassis hardware includes any one or any combination of backplane vital product data (VPD), a chassis light-emitting diode (LED), and a chassis temperature sensor:
wherein the backplane VPD is configured to obtain electronic label information of each chassis: the chassis LED is configured to indicate chassis fault information and chassis warning information; and the chassis temperature sensor is configured to measure a chassis environment temperature.

Optionally, the chassis management control module includes a first chassis management controller and a second chassis management controller;
the first chassis management controller and the second chassis management controller are both connected to the BMCs to achieve the network communication;
the first chassis management controller and the second chassis management controller achieve network redundancy; and a network bonding mode is an active-backup mode.

Optionally, each single-control affiliation device includes any one or any combination of controller area network (CAN) VPD, a CAN LED, a CAN sensor, a fantry, an input/output (IO) expansion card;
wherein the CAN VPD is configured to obtain electronic label information of a controller of the corresponding control node: the CAN LED is configured to indicate node fault information, node warning information, or node positioning information of the corresponding control node: the CAN sensor is configured to collect node temperature information and node voltage information of the corresponding control node; and the IO expansion card is configured to perform link expansion on a storage front-end or a storage back-end.

Optionally, the operating system layer includes a plurality of intelligent platform management interface tools corresponding to the control nodes; and
each intelligent platform management interface tool communicates with all the BMCs to access the BMCs through the intelligent platform management interface tool.

Optionally, the operating system layer is further configured to perform a firmware upgrade operation on the BMCs through the first chassis management controller or the second chassis management controller.

Optionally, the application layer includes a plurality of high-definition monitors corresponding to each control node;
the high-definition monitors are configured to obtain, by calling the corresponding BMC interfaces, the hardware data information cached by all the BMCs and manage a hardware by polling the BMCs and the main BMC; and
the high-definition monitors are connected to the cluster management center to synchronize the hardware data information obtained by the corresponding control nodes by accessing all the BMCs to the cluster management center.

Optionally, the main BMC has a virtual Internet protocol (IP), and the control nodes of the cluster access the main BMC through the virtual IP;
the processors are further configured to drift, in response to detecting that the main BMC is switched, the virtual IP to a current main BMC.

Optionally, the processors are further configured to:
preset the BMCs with physical serial numbers that are determined according to a switching order of the main BMC;
obtain heartbeat state information of the BMCs;
in response to the main BMC being not in place or being abnormal, determine whether a next candidate BMC adjacent to the physical serial number of the main BMC is in place and normal; and
in response to the next candidate BMC adjacent to the physical serial number of the main BMC is in place and normal, use the candidate BMC as the current main BMC.

The technical solutions provided by the present application have the advantages that through a network interconnection technology, each BMC is associated with each controller node of the storage product, so that each control node may access the data collected by the plurality of BMCs simultaneously and in real time, which achieves redundancy of the links and the control nodes and facilitates improving the reliability of the storage product. Furthermore, the hardware state of the entire chassis may also be monitored through the single control node, the chassis management efficiency is improved. In addition, each control node may send the collected data to the cluster management center in a unified way to keep the data consistent. Time-consuming data synchronization are not needed to be performed between all the BMCs, so that the timeliness is high, and the chassis management efficiency of the storage product may be further improved. Moreover, since each control node obtains full information, the data consistency may also be further improved.

It should be understood that the foregoing general descriptions and the following detailed descriptions are merely for illustration and not intended to limit the present disclosure.

### BRIEF DESCRIPTION OF THE DRAWINGS

In order to more clearly explain the technical solution of some embodiments in the present application or in the related art, the drawings required to be used in some embodiments or in the related art will be briefly introduced below. Obviously, the drawings in the following description are only some embodiments of the present application. Other drawings may also be obtained according to these drawings by a person skilled in the art without paying creative labor.

FIG. 1 is a structural diagram of a specific implementation of a chassis management system according to some embodiments of the present application;

FIG. 2 is a flowchart of steps of a chassis management method according to some embodiments of the preset application; and

FIG. 3 is a structural diagram of another specific implementation of a chassis management system according to some embodiments of the present application.

### DETAILED DESCRIPTION

In order to make a person skilled in the art better understand the solutions of the present disclosure, the present disclosure is further described in detail below with reference to the accompanying drawings and specific implementation modes. Apparently, the described embodiments are merely a part of the embodiments of the present disclosure and not all the embodiments. Based on the embodiments in the present disclosure, all other embodiments obtained by a person skilled in the art without paying creative work all fall within the protection scope of the present disclosure.

This specification and claims of the present application and terms “first”, “second”, “third”, “fourth”, and the like in the above drawings are used to distinguish different objects, but are not used to describe a specific order. In addition, the terms “include”, “has”, and any variant thereof are intended to cover a non-exclusive inclusion. For example, a process, a method, a system, a product, or a device that includes a series of steps or units is not limited to the listed steps or units, but may include steps or units that are not listed.

After the technical solutions of some embodiments of the present application are introduced, various non-restrictive implementations of the present application are illustrated in detail below.

First, referring to FIG. 1. FIG. 1 is a structural diagram of a specific implementation of a chassis management system according to some embodiments of the present application. Some embodiments of the present application may include the following contents.

The chassis management system may include a hardware layer 1, a firmware layer 2, an operating system layer 3, an application layer 4, and a cluster management center 5.

The hardware layer 1 includes a hardware device of a multi-controller storage product. This layer includes two types of hardware. One type of hardware is a hardware that is independently accessed and managed by a BMC of each control node, that is, a hardware belonging only to each control node. For ease of description, this type of hardware is referred to as a single-control affiliation device. Each control node of the multi-controller storage product corresponds to a group of single-control affiliation devices, and the number of groups of single-control affiliation devices is the same as the total number of controllers of the multi-controller storage product or control nodes; and the types and numbers of the single-control affiliation devices contained in each control node are the same. Each single-control affiliation device may be connected to an affiliated BMC through any type of bus. For ease of description, the other type of hardware may be referred to as a shared device. The shared device may only be accessed and managed by a main BMC, and there is only one group of shared devices. Due to that the main BMC is selected from the BMCs, and when the original main BMC fails or is unable to carry service, the main BMC may change, the shared device may be connected to the BMC of each control node through any type of bus. The shared device of the present embodiment may be configured to collect information of an entire chassis and configured to enable each control node of a cluster to be in network interconnection with a plurality of BMCs, respectively.

In the present embodiment, the firmware layer 2 is all programs written into an erasable programmable read only memory (EPROM) or an electrically erasable programmable read only memory (EEPROM), including driver programs stored in various hardware devices of the hardware layer 1. The firmware layer 2 includes not only BMCs corresponding to each controller, but also processors configured to manage the single-control affiliation devices of the corresponding control nodes and be responsible for selecting a main BMC for a current storage product. Each BMC is connected to one processor, that is, the number of the processors is the same as the total number of the controllers of the multi-controller storage product. The processors may include one or more processing cores, such as a 4-core processor and an 8-core processor, and the processors may also be a controller, a microcontroller, a microprocessor, other data processing chips, or the like. The processors may be implemented by using at least one hardware form, including digital signal processing (DSP), a field-programmable gate array (FPGA), a programmable logic array (PLA), and a complex programmable logic device (CPLD). Of course, the processors may also include a main processor and a coprocessor. The main processor is a processor configured for processing data in an awake state, and is also referred to as a central processing unit (CPU). The coprocessor is a low-power processor configured for processing data in a standby state. In some embodiments, the processors may be even integrated with graphics processing units (GPUs). The GPU is configured to render and draw content that needs to be displayed on a display screen, such as data information stored in the storage product. In some embodiments, the processors may further include an artificial intelligence (AI) processor. The AI processor is configured to process computing operations related to machine learning. Considering the overall system cost, the processor in the present embodiment may be a CPLD. Since the shared device in the hardware layer 1 includes hardware devices that achieves the network interconnection between each control node in the cluster and the BMCs, correspondingly, the firmware layer 2 may include a chassis management control module. The chassis management control module is configured to achieve the network communication.

In the present embodiment, the operating system layer 3 is configured to communicate with and access the BMCs. The operating system layer 3 may provide tools that achieve the communication with the BMCs. Each tool corresponding to one control node. One end of each tool is connected to a corresponding BMC interface of the application layer 4, and the other end is connected to each BMC through any type of bus. The operating system layer 3 provides connection channels between the application layer 4 and the BMCs of the firmware layer 2, so that the application layer 4 may access the operating system layer 3 by calling the BMC interfaces. Through the channels provided by the operating system layer 3, the BMCs are accessed on the basis of the network interconnection function provided by the chassis management control module, thus the hardware data information cached by the BMCs is obtained is achieved. The application layer 4 of the present embodiment includes a plurality of BMC interfaces. One BMC corresponds to one BMC interface. A user may obtain the data collected by all the BMCs through a human-computer interaction page provided by the application layer 4 and through any BMC interface. That is, each control node may obtain full data collected by each BMC of the multi-controller storage product. That is, each control node may obtain identical full data that may reflect running state information of the chassises. After the control node obtains the full data, all the obtained data may be sent to the cluster management center 5 in a unified manner. The cluster management center 5 is configured to manage the hardware data information, obtained by each control node by accessing all the BMCs. of all the chassises, thereby chassis management and control of the multi-controller storage product is achieved.

In the technical solutions provided by some embodiments of the present application, through a network interconnection technology, each BMC is associated with each controller node of the storage product, so that each control node may access the data collected by the plurality of BMCs simultaneously and in real time, which achieves redundancy of the links and the control nodes and facilitates improving the reliability of the storage product. Furthermore, the hardware state of the entire chassis may also be monitored through the single control node, so that the chassis management efficiency is improved. In addition, each control node may send the collected data to the cluster management center in a unified way to keep the data consistent. Time-consuming data synchronization is not needed to be performed between all the BMCs, so that the timeliness is high, and the chassis management efficiency of the storage product may be further improved. Moreover, since each control node obtains full information, the data consistency may also be further improved.

The above embodiments do not impose any limitations on the hardware included in the hardware layer 1. Based on the above embodiments, as an optional embodiment, the structure of the hardware layer 1 may include the following contents:

The single-control affiliation device of the present embodiment includes any one or any combination of the following: controller area network (CAN) vital product data (VPD), a CAN light-emitting diode (LED), a CAN sensor, a fantry, an input/output (I/O) expansion card. Of course, the controller of each control node also belongs to a single-control affiliation device.

The CAN VPD is configured to obtain electronic label information of the controller of the corresponding control node. VPD is a set of configuration and information data related to a specific group of hardware or software, which stores some important information of the device, such as a part number, a serial number, desired persistent information, and some data specified by the device. The CAN LED serves as a node indicator lamp for indicating node fault information, node warning information, or node positioning information of the corresponding control node, that is, for indicating a position or an alarm. The CAN sensor is configured to collect node temperature information and node voltage information of the corresponding control node. Correspondingly, the CAN sensor may include a node temperature sensor, a node voltage sensor, and the like. The fantry is configured for heat dissipation. The IO expansion card is configured to perform link expansion on a storage front-end or a storage back-end.

The shared device is a group of hardware arranged on a chassis frame and needed to be accessed by all the control nodes, including a chassis hardware, a network management board, and a chassis power supply. An inter-integrated circuit (I2C) does not support a simultaneous access as the simultaneous access may cause a hanging problem. The shared device may be connected to each BMC through the I2C and accessed by the selected main BMC node. It is realized that each control node accesses the shared device by accessing the BMC. The chassis hardware is configured to collect chassis information and indicate the chassis information. The chassis hardware may include any one or any combination of the following: backplane VPD, a chassis LED, and a chassis temperature sensor. The backplane VPD is configured to obtain electronic label information of a chassis; the chassis LED serves as a chassis indicator lamp to indicate chassis fault information and chassis warning information; and the chassis temperature sensor is configured to measure a chassis environment temperature. The network management board is configured to provide a network interconnection function to interconnect each control node of the cluster to the BMCs, respectively.

In an optional embodiment, in order to improve the reliability of the entire storage product, a network redundancy may be achieved through dual links to improve the link reliability, thereby the reliability of the storage product is improved. Based on this, the present embodiment may further include:
the chassis management control module may include a first chassis management controller CMC1 and a second chassis management controller CMC2. The first chassis management controller and the second chassis management controller are both connected to the BMCs for network communication. The first chassis management controller CMC1 and the second chassis management controller CMC2 achieve the network redundancy, and a network bonding mode is an active-backup mode.

In the present embodiment, in order to increase the network speed, the chassis management control module may use a network card bonding mode. That is, a plurality of physical network cards are virtualized into a virtual network card through software. After the configuration is completed. IPs and media access controls (MACs) of all the physical network cards will become the same. There are seven configuration modes for the network bonding mode: 1. Mode=0 (balance-rr, load balancing mode), which represents that load sharing round-robin is in conjunction with the aggregation non-negotiation mode of a switch. 2. Mode=1 (active-backup mode), where only one network card is active and the other network is standby. Since half of packets are discarded when a switch sends packets to two network cards, at this moment, if the switch is configured with the bonding mode, the switch will not function properly. 3. Mode=2 (balance-xor), which represents that XOR Hash load sharing is in conjunction with the aggregation non-negotiation mode of the switch (xmit_hash_policy is required). 4. Mode=3 (broadcast), which represents that all packets are sent from all interfaces, which is imbalanced, and only a redundancy mechanism is in conjunction with the aggregation non-negotiation mode of the switch. 5. Mode=4 (802.3ad), which represents that the 802.3ad protocol is supported to be in conjunction with a link aggregation control protocol (LACP) of the switch (xmit_hash_policy is required). 6. Mode=5 (balance-tlb (translation lookaside buffer)), which selects a slave for sending according to a load situation of each slave, and a current slave is used during receiving. 7. Mode=6 (balance-alb (automatic loop back)), which adds receive load balance (rlb) on the basis of tlb of Mode=5. In order to achieve the load balancing and redundancy of the network card, the present embodiment may use the active-backup mode of Bond1. Only one slave (slave device) is activated, and other slave interfaces may be activated only when the active slave interface is down. In the active-backup mode, if fault switching occurs at a time, one or more gratuitous address resolution protocol (ARP) requests may be sent on a newly activated slave interface. The main slave interface and all virtual local area network (VLAN) interfaces configured on this interface may send the gratuitous ARPs, and at least one IP address needs to be configured on these interfaces. The gratuitous ARPs sent on the VLAN interfaces may be accompanied by appropriate VLAN ids. This mode provides a fault-tolerant capability. In the present embodiment, the communication is achieved through the CMC1 by default. If the CMC1 fails or is not in place, the CMC2 is switched for network communication. Correspondingly, the network management board of the shared device in the hardware layer 1 may be a CMC management board

The above embodiments do not limit a bus that is used to connect the BMCs in the entire chassis management architecture. As the I2C is a simple, bidirectional two-wire synchronous serial bus, only two wires are needed to transmit information between the devices connected to the bus. As an optional embodiment, the hardware devices of the present embodiment may be connected to the BMCs through the I2C, that is, the hardware devices may be accessed through the I2C. Correspondingly, the processor is also configured to allocate an I2C address for each I2C and allocate corresponding address for each general-purpose input/output (GPIO).

The above embodiments do not limit the way provided by the operating system layer 3 for connection with the BMCs. As an optional embodiment, the operating system layer 3 may include a plurality of intelligent platform management interface tools (Ipmitools) corresponding to the control nodes, that is, the total number of the intelligent platform management interface tools is the same as the number of the control nodes of the multi-controller storage product. The Ipmitools may be used in a command-line manner in a Linux system, supporting both local operations and remote operations, and being able to work independently without relying on a CPU of a server, an internal memory, a storage, a power supply, and the like. Through the Ipmitools, functions of obtaining information of the sensor, displaying system log contents, remotely starting and shutting down a network, and the like may be achieved. Each intelligent platform management interface tool communicates with all the BMCs of the storage product to access the BMCs through the intelligent platform management interface tool. In this way, each control node may access the BMCs and obtain all the hardware data through the Ipmitools, which is simple and efficient.

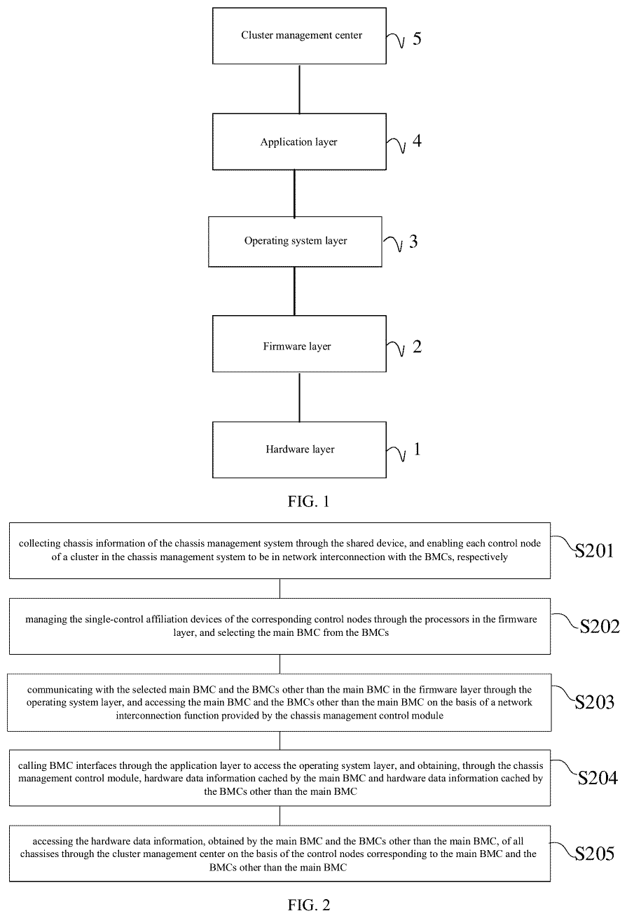

Further, in order to improve the practicability and convenience of the entire chassis management system, the operating system layer 3 may be further configured to perform a firmware upgrade operation on the BMCs through the first chassis management controller or the second chassis management controller. As shown in FIG. 2, firmware upgrade may be achieved through Yafu-upgrade.sh-firmare.sh.

The above embodiments do not impose any limitations on the software structure of the application layer 4. Based on the above embodiments, the application layer 4 of the present embodiment may include a plurality of high-definition monitors corresponding to the control nodes, that is, the total number of the high-definition monitors is the same as the number of the control nodes of the multi-controller storage product. The various high-definition monitors are configured to obtain, by calling the corresponding BMC interfaces, the hardware data information cached by all the BMCs and manage a hardware by polling the BMCs and the main BMC. The high-definition monitors are all connected to the cluster management center to synchronize the hardware data information obtained by the corresponding control nodes by accessing all the BMCs to the cluster management center. Of course, the application layer 4 may call interfaces through other monitors or in other ways to be connected to the operating system layer 3, and perform a BMC data obtaining operation, which does not affect the implementation of the present application.

The above embodiments do not impose any limitations on the selection method for the main BMC. Based on the above embodiments, the present application further provides a feasible selection method for the main BMC, which may include the following content:

the processors may be further configured to: preset the BMCs with physical serial numbers that are determined according to a switching order of the main BMC: obtain heartbeat state information of the BMCs: if it is detected that the main BMC is not in place or is abnormal, determine whether a next candidate BMC adjacent to the physical serial number of the main BMC is in place and normal; and if the next candidate BMC adjacent to the physical serial number of the main BMC is in place and normal, use the candidate BMC as a current main BMC.

In the present embodiment, the processors of the control nodes communicate with each other, and physical positions of the control nodes of the multi-controller storage product are 1 to n from left to right. Each BMC and other BMCs may send a heartbeat notification of its own heartbeat state every 5 s. If the BMC, also referred to as the BMC1, of the control node 1 is in place and normal, the BMC1 is the main BMC. If the BMC of the control node 1 is not in place or abnormal, and the BMC, also referred to as the BMC2, of the control node 2 is in place and normal, the BMC2 is selected as the main BMC, and so on in the order from 1 to n.

In order to further improve the chassis management efficiency and reduce the coupling degree between all devices, based on the above embodiments, each BMC of the present embodiment has a separate and fixed IP, and the main BMC is also configured with a virtual IP. The main BMC has a virtual IP, and the control nodes of the cluster access the main BMC through the virtual IP. The processors are further configured to drift, when it is detected that the main BMC is switched, the virtual IP to the current main BMC. The control nodes or upper layer of services does not need to query the IP of the main BMC and may use the virtual IP to access the main BMC all the time. By dynamically drifting the virtual IP to the current main BMC, decoupling between all the devices is achieved.

In some embodiments, the above chassis management system may further include a display screen, an input/output interface, a communication interface or a network interface, a power supply, and a communication bus. The display screen and the input/output interface such as a keyboard belong to user interfaces, and available user interfaces may further include a standard wired interface, a wireless interface, and the like. Optionally, in some embodiments, a display may be an LED display, a liquid crystal display, a touch-control liquid crystal display, an organic light emitting diode (OLED) touch device, and the like. The display may also be appropriately referred to as a display screen or a display unit, configured to display information processed by the chassis management system during the execution of chassis management and display a visual user interface. The communication interface may optionally include a wired interface and/or a wireless interface, such as a WI-FI interface and a Bluetooth interface, typically configured to establish communication connections between the chassis management system and other electronic devices. The communication bus may be a peripheral component interconnect (PCI) bus, an extended industry standard architecture (EISA) bus, or the like. The bus may be divided into an address bus, a data bus, a control bus, and the like.

It should be understood that if some chassis management methods involved in the chassis management system in the above embodiments are implemented in the form of software functional units and sold or used as stand-alone products, they may be stored in a non-volatile computer-readable storage medium. Based on this understanding, the technical solutions of the present application essentially, or the part that contributes to the prior art, or all or some of the technical solutions, may be embodied in the form of a software product. The computer software product is stored in a non-volatile readable storage medium to execute all or some of the steps of the methods in the various embodiments of the present application. The aforementioned non-volatile readable storage medium includes: a USB flash disk, a mobile hard disk drive, a read-only memory (ROM), a random access memory (RAM), an electrically erasable programmable ROM, a register, a hard disk drive, a multimedia card, a card type memory (such as SD or DX memory), a magnetic memory, a removable magnetic disk, a CD-ROM, a magnetic tape or an optical disk, and other media that may store program codes.

Specifically, referring to FIG. 2. FIG. 2 is a flowchart of steps of a chassis management method according to some embodiments of the present application. The chassis management method is mainly applied to the chassis management system as shown in FIG. 1. The chassis management system includes a hardware layer, a firmware layer, an operating system layer, an application layer, and a cluster management center. The hardware layer includes a shared device accessed by a main BMC and single-control affiliation devices managed by the plurality of BMCs; and the firmware layer includes a chassis management control module, the plurality of BMCs, and processors corresponding to the BMCs.

The method specifically includes the following steps:

Step S201: collecting chassis information of the chassis management system through the shared device, and enabling each control node of a cluster in the chassis management system to be in network interconnection with the BMCs, respectively.

The shared device includes a chassis hardware arranged on a chassis frame, a network management board, and a chassis power supply.

Specifically, the chassis information of the chassis management system may be collected and indicated through the chassis hardware. Each control node of the cluster is interconnected to the BMCs respectively through a network interconnection function provided by the network management board.

The chassis hardware includes any one or any combination of the following: backplane VPD, a chassis LED and a chassis temperature sensor.

When the chassis information is collected and indicated through the chassis hardware, electronic label information of a chassis is obtained through the backplane VPD, and/or, chassis fault information and chassis warning information are indicated through the chassis LED, and/or, a chassis environment temperature is measured through the chassis temperature sensor.

In some embodiments of the present application, after enabling each control node in the cluster to be in network interconnection with the BMCs respectively through the shared device in the hardware layer, based on that the firmware layer may be first connected to the BMCs through the chassis management control module in the firmware layer to achieve network communication, a network bonding mode is an active-backup mode, so that conditions are created for the processors in the firmware layer to subsequently manage the single-control affiliation devices of the corresponding control nodes and select the main BMC from the BMCs.

Specifically, the chassis management control module includes a first chassis management controller and a second chassis management controller. In a case where the first chassis management controller and the second chassis management controller are both connected to the BMCs for network communication, the first chassis management controller and the second chassis management controller achieve a network redundancy, and a network bonding mode is regarded as an active-backup mode.

Step S202: managing the single-control affiliation devices of the corresponding control nodes through the processors in the firmware layer, and selecting the main BMC from the BMCs.

Each single-control affiliation device includes any one or any combination of the following: CAN VPD, a CAN LED, a CAN sensor, a fantry, and an IO expansion card.

Specifically, the processors may manage the CAN VPD configured to obtain the electronic label information of a controller of the corresponding control node, and/or, the CAN LED configured to indicate node fault information or node warning information or node positioning information of the corresponding control node, and/or, the CAN sensor configured to collect node temperature information and node voltage information of the corresponding control node, and/or, the IO expansion card configured to perform link expansion on a storage front-end or a storage back-end, and select the main BMC from the BMCs on the basis of the independent access to the BMC of each control node.

In addition, after selecting the main BMC from the BMCs, the processors may further switch the main BMC.

In some embodiments of the present application, the processors may drift the virtual IP to a current main BMC when detecting that the main BMC is switched. Specifically, the processors may preset the BMCs with physical serial numbers that are determined according to a switching order of the main BMC and obtain heartbeat state information of the BMCs. If it is detected that the main BMC is not in place or is abnormal, whether a next candidate BMC adjacent to the physical serial number of the main BMC is in place and normal is determined; and if the next candidate BMC adjacent to the physical serial number of the main BMC is in place and normal, the candidate BMC is used as a current main BMC.

Step S203: communicating with the selected main BMC and the BMCs other than the main BMC in the firmware layer through the operating system layer, and accessing the main BMC and the BMCs other than the main BMC on the basis of a network interconnection function provided by the chassis management control module.

The operating system layer includes a plurality of intelligent platform management interface tools corresponding to the control nodes. During accessing the BMCs, the intelligent platform management interface tools may communicate with all the BMCs and access the BMCs. The accessed BMCs may include the main BMC selected by the processors and the BMCs, namely slave BMCs, other than the main BMC.

In addition to communicating with the BMCs, the operating system layer may also perform a firmware upgrade operation on the accessible BMCs.

Specifically, a firmware upgrade operation may be performed on the BMCs through the operating system layer on the basis of the first chassis management controller or the second chassis management controller.

Step S204: calling BMC interfaces through the application layer to access the operating system layer, and obtaining, through the chassis management control module, hardware data information cached by the main BMC and hardware data information cached by the BMCs other than the main BMC.

The shared device may only be accessed and managed by the main BMC. The hardware data information cached by the main BMC may include the chassis information collected by the shared device and other hardware data information. The hardware data information cached by the BMCs, namely the slave BMCs, other than the main BMC only includes the corresponding hardware data information and does not include the chassis information. That is, the hardware data information cached by the main BMC may include the chassis information collected by the shared device, so that based on the control nodes corresponding to the main BMC and the slave BMCs, all the hardware data information may be subsequently sent in a unified way.

Specifically, when the BMC interfaces are called through the application layer to access the operating system layer, the application layer includes a plurality of high-definition monitors corresponding to the control nodes. At this moment, the hardware data information cached by all the BMCs may be obtained through the high-definition monitors by calling the corresponding BMC interfaces, and the hardware may be managed by polling the BMCs and the main BMC. The high-definition monitors are connected to the cluster management center. At this moment, the hardware data information obtained by the corresponding control nodes by accessing all the BMCs may also be synchronized to the cluster management center through the various high-definition monitors.

Step S205: accessing the hardware data information, obtained by the main BMC and the BMCs other than the main BMC, of all chassises through the cluster management center on the basis of the control nodes corresponding to the main BMC and the BMCs other than the main BMC.

The main BMC has a virtual IP. At this moment, through the control nodes of the cluster, the main BMC may be accessed on the basis of the virtual IP, and the BMCs other than the main BMC may be accessed on the basis of any type of bus connected to the BMC of each control node, to obtain the hardware data information, obtained by the control nodes corresponding to the main BMC and the BMCs other than the main BMC by accessing the main BMC and the BMCs other than the main BMC, of all the chassises.

In some embodiments of the present application, each BMC may be associated with each control node of the storage product, and by using the selected main BMC, it is realized that the chassis information collected by the shared device is accessed. Unified access to other control nodes may be achieved on the basis of the plurality of associated control nodes, and the collected data may be sent to the cluster management center on the basis of each control node to maintain the consistency of the data and ensure data synchronization on different control nodes.

It should be noted that for the method embodiment, for a brief description, they are all described as a series of action combinations. However, a person skilled in the art should be aware that some embodiments of the present application are not limited by the order of the described actions, as according to some embodiments of the present application, certain steps may be performed in other orders or simultaneously. Secondly, a person skilled in the art should also be aware that the embodiments described in the specification are all preferred embodiments, and the actions involved may not be necessary for some embodiments of the present application.

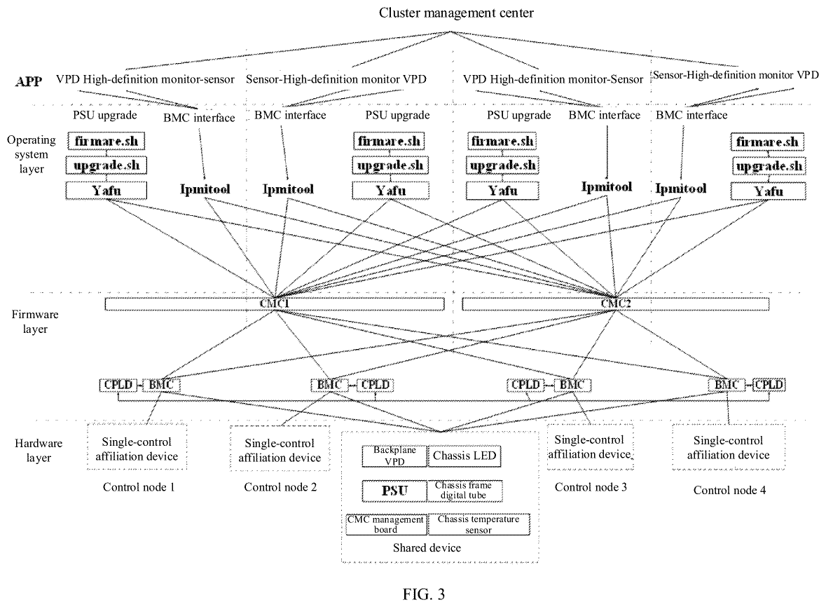

In order to enable a person skilled in the art to have a clearer understanding of the technical solutions of the present application, the present application also takes the chassis management system of 4-control unified high-end storage as an example to explain the chassis management architecture of a unified high-end storage. As shown in FIG. 3, the chassis management architecture may include the following content:
the chassis management architecture of unified high-end storage includes a hardware layer, a firmware layer, an operating system layer, an application (APP) layer, and a cluster management center from bottom to top. The hardware layer includes single-control affiliation devices respectively corresponding to four controllers and a shared device which needs to be accessed by all the four controllers. The firmware layer includes BMCs and CPLDs respectively corresponding to each controller, and further include a CMC1 and a CMC2. The operating system layer includes Ipmitools respectively corresponding to the four controllers, and performs a firmware upgrade operation on the corresponding BMCs and an upgrade operation on corresponding power supply units (PSUs) through the CMC1 or the CMC2. The APP layer includes HD monitors and BMC interfaces which respectively correspond to the four controllers. The HD monitor of each controller is connected to the cluster management center. One end of each Ipmitool is connected to the corresponding BMC interface, and the other end is connected to the BMCs of the four controllers. The CMC1 and the CMC2 are connected to each Ipmitool and each BMC respectively. The CPLDs are interconnected, and each BMC is connected to the corresponding single-control affiliation device and the shared device through an I2C.

Each single-control affiliation device may include: CAN VPD/a CAN LED/a sensor/a factory/an IO expansion card. The shared device may include backplane VPD/a chassis LED/a CMC network management board/a chassis temperature sensor, and only the main BMC among the four BMCs may access the shared device. The BMCs are responsible for collecting information and monitoring of hardware such as the single-control affiliation devices, the shared device, the CPLDs, the CMC1, and the CMC2, including monitoring the reading and writing of the VPD, accessing LED states, reading temperatures, reading voltages, reading CMC network states, and the like. The CPLDs are configured to allocate addresses for the I2C/GPIO and directly control and manage the aforementioned hardware. For example, the VPD records information needing to be persisted; and the LED is configured with positioning indication, warning indication, state indication, temperature, voltage, and fantry speed control, and the like. The CPLDs are further responsible for selecting the main BMC from the four BMCs. The CMC management board is responsible for network communication, and the CMC1 and the CMC2 achieve a network redundancy. An active-backup mode bond1 is used. The Ipmitools of the operating system layer are responsible for communicating with all the BMCs, and the controllers may access the devices of the four BMCs through the Ipmitools. The Hd monitors are configured to call the BMC interface information to collect hardware information cached by the BMCs. That is, the Hd monitors may read all the hardware information cached on all the BMCs through the Ipmitools, and the hardware information is cached into the Hd monitors. The hardware may be managed by polling the information of the four BMCs and the main BMC. For example, the LED is configured with positioning indication, state indication, temperature, voltage, and fantry speed control, and the like. The cluster management center is responsible for unified management, and each controller may collect complete information of an entire chassis through the four BMCs, and then synchronize the information to the cluster management center to achieve the redundancy of data links and the data consistency

Based on the chassis management architecture mentioned above, after the system is powered on the CPLDs of the four controllers communicate with each other to select a main BMC. A routine test is carried out on the BMC1, the BMC2, the BMC3, and the BMC4, and states of all single node hardware, namely the single-control affiliation devices, are managed. The main BMC, such as the BMC1, is responsible for managing the routine test of the shared device. If the BMC1 fails to access the shared device, the CPLDs switch the main BMC1 to the BMC2. When an operating system service starts to run. Hd monitor1, Hd monitor2, Hd monitor3, and Hd monitor4 of the controllers access the Ipmitools through the BMC interface layer, and then access the BMC1, the BMC2, the BMC3, and the BMC4 through the CMC1, ultimately achieving hardware access management. During the chassis management, if the CMC1 fails, the operating system layer will switch the network to the CMC2, and the Hd monitors of the four controllers may obtain hardware states and upload the hardware states to the cluster management center.

Based on the chassis management architecture mentioned above, the present embodiment may achieve link, network, and node redundancies. For example, if the BMC1 of the controller 1 fails to access a PSU or an I2C link fails, the BMC1 notifies the CPLD of controller 1. The various CPLDs communicate with each other and select the BMC2 as a main BMC, namely, the main BMC is switched to the BMC2 of the controller 2. The BMC2 of the controller 2 accesses the PSU. Each controller accesses the BMC2 through the network of the CMC1 to obtain the PSU data, thus a hardware link redundancy is achieved. By default, all the controllers access the BMC1, the BMC2, the BMC3, and the BMC4 through the CMC1, ultimately obtaining all the hardware states. If the CMC1 fails or is unplugged, the network is automatically switched to the CMC2, and all the controllers access the BMC1, the BMC2, the BMC3, and the BMC4 through the CMC2, ultimately obtaining all the hardware states. By default, each controller may manage four chassises through the BMC1, the BMC2, the BMC3, and the BMC4. If three controllers have a failure in the operating system layer, for example, if the OS1, the OS2, and the OS3 fail, the entire chassis may still monitor the hardware states of the BMC1, the BMC2, the BMC3, and the BMC4 through the OS4, and issue commands through the OS4.

As may be seen from the above, some embodiments of the present application may achieve single control to monitor the hardware state of the entire chassis. Achieving the network redundancy improves the link reliability. Achieving the link redundancy improves the reliability of the storage product. Achieving the node redundancy improves the reliability. After the full information is obtained through single control, the full information is sent to the cluster in a unified way to achieve the data consistency, thus full collection for a single node is achieved and the data consistency is improved.

The various embodiments in this specification are described in a progressive manner, and each embodiment focuses on differences from other embodiments. The same or similar parts between all the embodiments may be referred to each other. A person skilled in the art may further realize that units and algorithm steps of all the examples described in the foregoing embodiments disclosed herein may be implemented by electronic hardware, computer software, or a combination thereof. To clearly describe the interchangeability between the hardware and the software, the foregoing has generally described compositions and steps of each example based on functions. Whether these functions are implemented as hardware or software depends on particular application and design constraint conditions of the technical solutions. A person skilled in the art may use different methods to implement the described functions for each particular application, but it should not be considered that the implementation goes beyond the scope of the present application.

The above provides a detailed introduction to the chassis management system and the corresponding chassis management method provided by the present application. The principles and implementations of the present application are explained herein with specific examples, and the explanations of the above embodiments are only used to help understand the method of the present application and a core idea of the method. It should be pointed out that a person of ordinary skill in the art may also make several improvements and modifications to the present application without departing from the principles of the present application, and these improvements and modifications also fall within the scope of protection of the claims of the present application.

1. A chassis management system, comprising a hardware layer, a firmware layer, an operating system layer, an application layer, and a cluster management center;
wherein the hardware layer comprises a shared device accessed by a main baseboard manager controller (BMC) and a single-control affiliation device managed by each BMC, and the shared device is configured to collect chassis information and configured to enable each control node of a cluster to be in network interconnection with a plurality of BMCs, respectively;
the firmware layer comprises a chassis management control module, the plurality of BMCs, and processors corresponding to the BMCs; the processors are configured to manage the single-control affiliation devices of corresponding control nodes and select the main BMC from the BMCs; the chassis management control module is configured to achieve network communication;
the operating system layer is configured to communicate with and access the BMCs;
the application layer is configured to access the operating system layer by calling BMC interfaces and obtain hardware data information cached by the BMCs through the chassis management control module; and
the cluster management center is configured to manage the hardware data information, obtained by each control node by accessing all the BMCs, of all chassises.

2. The chassis management system according to claim 1, wherein the shared device comprises a chassis hardware arranged on a chassis frame, a network management board, and a chassis power supply; the shared device is connected to each BMC through an inter-integrated circuit (I2C);
the chassis hardware is configured to collect the chassis information and indicate the chassis information; and
the network management board is configured to provide a network interconnection function to interconnect each control node of the cluster to the BMCs, respectively.

3. The chassis management system according to claim 2, wherein the chassis hardware comprises any one or any combination of backplane vital product data (VPD), a chassis light-emitting diode (LED), and a chassis temperature sensor;
wherein the backplane VPD is configured to obtain electronic label information of each chassis; the chassis LED is configured to indicate chassis fault information and chassis warning information; and the chassis temperature sensor is configured to measure a chassis environment temperature.

4. The chassis management system according to claim 2, wherein the chassis management control module comprises a first chassis management controller and a second chassis management controller;
the first chassis management controller and the second chassis management controller are both connected to the BMCs to achieve the network communication;
the first chassis management controller and the second chassis management controller achieve network redundancy; and a network bonding mode is an active-backup mode.

5. The chassis management system according to claim 4, wherein the operating system layer is further configured to perform a firmware upgrade operation on the BMCs through the first chassis management controller or the second chassis management controller.

6. The chassis management system according to claim 1, wherein each single-control affiliation device comprises any one or any combination of controller area network (CAN) VPD, a CAN LED, a CAN sensor, a fantry, an input/output (IO) expansion card;
wherein the CAN VPD is configured to obtain electronic label information of a controller of the corresponding control node; the CAN LED is configured to indicate node fault information, node warning information, or node positioning information of the corresponding control node; the CAN sensor is configured to collect node temperature information and node voltage information of the corresponding control node; and the IO expansion card is configured to perform link expansion on a storage front-end or a storage back-end.

7. The chassis management system according to claim 1, wherein the operating system layer comprises a plurality of intelligent platform management tools corresponding to the control nodes; and
each intelligent platform management interface tool communicates with all the BMCs to access the BMCs through the intelligent platform management interface tool.

8. The chassis management system according to claim 1, wherein the application layer comprises a plurality of high-definition monitors corresponding to each control node;
the high-definition monitors are configured to obtain, by calling the corresponding BMC interfaces, the hardware data information cached by all the BMCs and manage a hardware by polling the BMCs and the main BMC; and
the high-definition monitors are connected to the cluster management center to synchronize the hardware data information obtained by the corresponding control nodes by accessing all the BMCs to the cluster management center.

9. The chassis management system according to claim 1, wherein the main BMC has a virtual Internet protocol (IP), and the control nodes of the cluster access the main BMC through the virtual IP;
the processors are further configured to drift, in response to detecting that the main BMC is switched, the virtual IP to a current main BMC.

10. The chassis management system according to claim 9, wherein the processors are further configured to:
preset the BMCs with physical serial numbers that are determined according to a switching order of the main BMC;
obtain heartbeat state information of the BMCs;
in response to the main BMC being not in place or being abnormal, determine whether a next candidate BMC adjacent to the physical serial number of the main BMC is in place and normal; and
in response to the next candidate BMC adjacent to the physical serial number of the main BMC is in place and normal, use the candidate BMC as the current main BMC.

11. The chassis management system according to claim 1, wherein the single-control affiliation device is a hardware that is independently accessed and managed by the BMC of each control node.

12. A chassis management method, applied to the chassis management system according to claim 1, wherein the chassis management system comprises a hardware layer, a firmware layer, an operating system layer, an application layer, and a cluster management center, wherein the hardware layer comprises a shared device accessed by a main BMC and single-control affiliation devices managed by BMCs; the firmware layer comprises a chassis management control module, a plurality of BMCs, and processors corresponding to the BMCs; the method comprises:
collecting the chassis information of the chassis management system through the shared device, and enabling each control node of the cluster in the chassis management system to be in network interconnection with the BMCs, respectively;
managing the single-control affiliation devices of the corresponding control nodes through the processors in the firmware layer, and selecting the main BMC from the BMCs;
communicating with the selected main BMC and the BMCs, other than the main BMC, in the firmware layer through the operating system layer, and accessing the main BMC and the BMCs other than the main BMC on the basis of a network interconnection function provided by the chassis management control module;
calling the BMC interfaces through the application layer to access the operating system layer, and obtaining, through the chassis management control module, hardware data information cached by the main BMC and hardware data information cached by the BMCs other than the main BMC, wherein the hardware data information cached by the main BMC comprises the chassis information acquired by the shared device; and
accessing the hardware data information, obtained by the main BMC and the BMCs other than the main BMC, of all the chassises through the cluster management center on the basis of the control nodes corresponding to the main BMC and the BMCs other than the main BMC.

13. The method according to claim 12, wherein the shared device comprises a chassis hardware arranged on a chassis frame, a network management board, and a chassis power supply; and collecting the chassis information of the chassis management system through the shared device, and enabling each control node of the cluster in the chassis management system to be in network interconnection with the BMCs, respectively, comprises:
collecting the chassis information of the chassis management system through the chassis hardware, and indicating the chassis information; and
interconnecting each control node of the cluster to the BMCs respectively through a the network interconnection function provided by the network management board.

14. The method according to claim 13, wherein the chassis hardware comprises any one or any combination of backplane VPD, a chassis LED, and a chassis temperature sensor;
collecting the chassis information through the chassis hardware, and indicating the chassis information comprises:
obtaining electronic label information of a chassis through the backplane VPD, and/or, indicating chassis fault information and chassis warning information through the chassis LED, and/or, measuring a chassis environment temperature through the chassis temperature sensor.

15. The method according to claim 12, wherein the chassis management control module in the firmware layer comprises a first chassis management controller and a second chassis management controller, and the method further comprises:
connecting both the first chassis management controller and the second chassis management controller to the BMCs to achieve the network communication; and
performing network redundancy through the first chassis management controller and the second chassis management controller, and setting a network bonding mode to be an active-backup mode.

16. The method according to claim 15, wherein each single-control affiliation device comprises any one or any combination of CAN VPD, a CAN LED, a CAN sensor, a fantry, an IO expansion card;
managing the single-control affiliation devices of the corresponding control nodes through the processors in the firmware layer, and selecting the main BMC from the BMCs comprises:
managing, through the processors, the CAN VPD responsible for obtaining the electronic label information of a controller of the corresponding control node, and/or, the CAN LED responsible for indicating node fault information or node warning information or node positioning information of the corresponding control node, and/or, the CAN sensor responsible for collecting node temperature information and node voltage information of the corresponding control node, and/or, the IO expansion card responsible for performing link expansion on a storage front-end or a storage back-end; and
selecting the main BMC from the BMCs on the basis of an independent access to the BMC of each control node.

17. The method according to claim 16, wherein the method further comprises:
drifting a virtual IP to a current main BMC through the processors in response to detecting that the main BMC is switched,
wherein drifting the virtual IP to the current main BMC through the processors in response to detecting that the main BMC is switched comprises:
presetting, through the processors, the BMCs with physical serial numbers that are determined according to a switching order of the main BMC, and obtaining heartbeat state information of the BMCs;
in response to the main BMC being not in place or is abnormal, determining whether a next candidate BMC adjacent to the physical serial number of the main BMC is in place and normal; and
in response to the next candidate BMC adjacent to the physical serial number of the main BMC is in place and normal, using the candidate BMC as the current main BMC.

18. The method according to claim 12, wherein the operating system layer comprises a plurality of intelligent platform management interface tools corresponding to the control nodes; and communicating with the selected main BMC and the BMCs, other than the main BMC, in the firmware layer through the operating system layer, and accessing the main BMC and the BMCs other than the main BMC on the basis of the network interconnection function provided by the chassis management control module comprises:
communicating with all the BMCs through each intelligent platform management interface tool, and accessing the BMCs through the intelligent platform management interface tool.

19. The method according to claim 18, wherein the chassis management control module in the firmware layer comprises a first chassis management controller and a second chassis management controller; and the method further comprises:
performing a firmware upgrade operation on the BMCs through the operating system layer on the basis of the first chassis management controller or the second chassis management controller.

20. The method according to claim 12, wherein the application layer comprises a plurality of high-definition monitors corresponding to each control node;
calling the BMC interfaces through the application layer to access the operating system layer, and obtaining, through the chassis management control module, the hardware data information cached by the main BMC and the hardware data information cached by the BMCs other than the main BMC comprises:
obtaining the hardware data information cached by all the BMCs through the high-definition monitors by calling the corresponding BMC interfaces, and managing the hardware by polling the BMCs and the main BMC, wherein the high-definition monitors are all connected to the cluster management center; and
the method further comprises:
synchronizing, through the high-definition monitors, the hardware data information obtained by the corresponding control nodes by accessing all the BMCs to the cluster management center.

21. (canceled)
